(19) United States
(12) Patent Application Publication
(10) Pub. No.: US 2007/0094958 A1
(43) Pub. Date: May 3, 2007

(54) Apparatus and methods for trim used with building siding

(76) Inventor: Riley Rogers, Boise, ID (US)

Correspondence Address: Ken J. Pedersen;Pedersen & Company, PLLC, P.O. Box 2666, Boise, ID, 83701-2666, US

(21) Appl. No.: 11/241,203

(22) Filed: Sep. 30, 2005

(51) Int. Cl. E06B 1/04

(52) U.S. Cl. 52/211

(57) ABSTRACT

A trim system for exterior siding includes interlocking trim units that may be installed without nails, screws, or other fasteners being visible. The preferred trim system includes an offset between its two back panels, which offset receives, shields, and conceals a sheet(s) of insulation, and a relief portion which gives the trim system a three-dimensional appearance. Other features of the trim system, such as preferred overlapping or bending tabs and corners, help to keep water out of the trim units and away from the insulation and rear surfaces of the siding.

### BACKGROUND OF THE INVENTION

1. Field of the Invention

The present invention relates to a window trimming system, and, more particularly, to a window trimming system that is self-interlocking, and is capable of cooperating with siding and insulation of building exteriors.

2. Related Art

The use of siding on houses and other buildings is becoming more common. Such siding is typically made of aluminum or other metal, or vinyl material and is attached along the outside face of the building, to form create the decorative and protective building exterior covering during original construction, or, alternatively, to “re-side” an older building by covering the original exterior. In order to complete the exterior covering of the house or other building, various types of finishing accessories are needed. Typically, when finishing-off a window or a door with preexisting wood trim, an aluminum or vinyl cap C is placed over the original wood trim T and a J-channel J is nailed next to the original wood trim (see FIG. 1A). As shown in FIG. 1A, insulation is positioned between the outside/exterior of the house O and behind the J-channel J. Herein, the “outside” or “exterior” of the building prior to siding is called-out as “O” whether it is the original building exterior in a retrofit situation or the new construction exterior prior to siding. The J-channel J acts as a clip or bracket that forms a pocket for receiving the ends or side edges of the siding S.

J-channels have presented some problems regarding maintenance of the siding and protection for the house. Since a portion of the J-channel J is behind the siding S, as the rain runs along the outer face of the siding adjacent to a window or door, there is a tendency for the rain to flow along the J-channel and thereby reach behind the siding S and/or cap C to contact the inner materials, that is, the wooden or composite materials or insulation. Such continued rain and moisture may deteriorate the wood of the original trim, the original exterior of the building, and/or even other materials of the building, such as studs, walls, or flooring.

Other conventional trimming, called conventional “lineal” or conventional “window wrap,” has been used in exterior siding systems (see FIGS. 1B and 2B). Insulation I is placed over the exterior O of the building, in a manner similar to that in FIGS. 1A and 2A, but, instead of capping an existing trim member T and “clipping” the siding S beside the capped trim with a J-channel, the lineal L forms the trim around the window frame and also the retaining system for the ends/edges of the siding. The lineal L comprises a flange U behind the siding S, and a pocket for the siding end or side edge. Unlike the J-channel, however, the panel forming the outer leg of the pocket bends “back on itself” (a 180 degree bend) at B to extend toward the window to form a trim panel P, and bends 90 degrees at G and also at H. The thickness of the lineal L at B is typically equal to two thicknesses of the metal or vinyl sheeting forming the lineal L. End panel E and outer end OE are parallel to each other and substantially the same length. The space SP between end panel E and outer end OE, and between the plane of flange U and the trim panel P (or, between the insulation I and the trim panel P) is typically empty. A screw, nail, or other fastener (not shown) is driven through the flange U, through insulation I, and into the exterior O of the building, to attach the conventional lineal L to the building. Further, a visible fastener F, such as a screw, nail, grommet, or rivet, is used to connect the trim panels P of two trim units meeting, for example, at a 90 angle joint, but typically does not extend into the insulation I or building exterior O. In FIG. 1B, the fastener F is shown extending through one trim panel P rather than through the trim panels of two units, as FIG. 1B schematically represents the conventional trim system by showing only one trim unit. It will be understood, however, that two of the lineals L meet at a corner and would be fastened to each other by fastener F that is visible on the finished installation, as shown in FIG. 2B. As may be seen from FIG. 1B, the lineal L forms the trim around the window frame, but may leave portions of the insulation I exposed for view or at least available to moisture.

Both J-channel trimming and conventional lineal trimming are fairly unaesthetic. They result in a flat-looking exterior wall and window area. The J-channel and siding (FIG. 1A) tend to be on about the same plane as the outer/front surface of the cap C, or even on a plane that is forward from (farther out than) the cap C, in which case the cap C and the window frame both seem “sunken” relative to the surrounding J-channel and siding. The lineal L (FIG. 1B) has, overall, a thickness about the same as the J-channel, and its trim panel P is nearly co-planar with the outer surface of the siding S. Thus, the inventor believes, these conventional siding systems have a very two-dimensional appearance. The inventor believes the conventional systems do not give the illusion of being a wood frame around the window; instead, the siding S is generally flush with the original wood trim T or the lineal trim.

Further, in both the conventional J-channel-and-cap system and conventional lineal system, the fasteners F required to secure the window trimming are visible in the finished installation, and therefore, clearly are not reminiscent of quality finish carpentry and wood trim. Also, in some applications, the structure against which the J-channel is placed is not smooth and straight, and so the J-channel may not provide a smooth connection to the cap or other window frame/trim, and, accordingly, bumps, dislocations and open spaces may occur around windows and door. Additionally, using J-channels and caps C means handling and installation of multiple pieces to create the trim and to hold the siding ends/edges.

### SUMMARY OF THE INVENTION

The present invention relates generally to trimming for building siding systems, and more particularly to a trimming system that is self interlocking and aesthetically-pleasing and can be used in combination with siding and insulation for windows, doors, or other regions on a building. The trimming system comprises a plurality of trim units that interlock at or near their ends. The preferred interlocking cooperation between trim units, when used in conjunction with fasteners extending from hidden portions of one or more of the trim units into a building surface, connects the trim units to each other and securely attaches the assembly to the building, without a need for fasteners to connect the trim units to each other. The trim units preferably have cooperating flanges that hook around each other or otherwise interlock at a location on the finished, installed trim that is not visible to a viewer of the building.

Further, a trim unit may include tab(s) that bend/curve across a joint between two trim units to help keep water out of the trim and away from inner materials of the building, and/or that frictionally grip(s) the cooperating trim unit to enhance stability of the joint without negatively impacting the aesthetics of the trim and the joint.

The trim units may each include an offset region for receiving and concealing or shielding insulation, wherein the offset region may be formed by two rear flanges or panels being generally parallel to each other but not coplanar, wherein the distance between said two rear flanges or panels forms a gap for the insulation that is generally parallel to the siding and to the front, visible panel of the trim.

The trim units may include a relief feature, wherein the front, visible panel of each trim unit is distanced from the siding a significant distance. The front panel is preferably the front wall of a overlapping or overhanging trim portion with closed sides that extends over the siding and give the trim system a three-dimensional appearance similar to traditional wood trim.

Preferably, there are no threaded fasteners or other fasteners, either for attaching the trim to the building or for attaching trim units to each other, that are visible in the finished, installed trim system. More preferably, there are no fasteners between two trim units, and they are instead connected by their interlocking cooperation and further hindered from separating by virtue of their attachment to the building. This way, in the preferred system, the viewer of the trim system on the outside of the building does not see nails, screws, or other fasteners on the outside of the trim system, as any threaded fasteners or other fasteners are hidden inside the trim units or underneath the siding.

### BRIEF DESCRIPTION OF THE DRAWINGS

FIG. 1A is a schematic, top cross-sectional view of one type of prior art window trimming, using a J-channel.

FIG. 1B is a schematic, top cross-sectional view of another prior art window trimming, using “conventional lineal” or “conventional wrap around” window trimming.

FIG. 2A is a front, partial (lower left corner) view of the prior art window trimming installation of FIG. 1A.

FIG. 2B is a front, partial (lower left corner) view of the prior art window trimming installation of FIG. 1B.

FIG. 3 is a front view of a siding and window trimming installation according to one embodiment of the invention.

FIG. 4A is a cross-sectional perspective view of the general shape/profile of one embodiment of the trim unit, taken about midway between two specialized ends (A-end and/or B-end). This figure also represents an end view of the preferred trim units prior to cutting/forming their specialized ends.

FIG. 4B is a schematic end cross-sectional view showing installation of one embodiment of an invented trim unit.

FIG. 5 is a left-front perspective, partial view of one embodiment of a lower left corner of the invented window trimming system.

FIG. 6 is a right perspective view of the vertical trim panel shown in FIG. 5.

FIG. 7 is a left perspective view of the horizontal trim panel shown in FIG. 6.

FIG. 8 is a front view of the corner trim system shown in FIG. 5, with dashed lines showing hidden structure, and without siding or insulation shown.

FIG. 9 is a top view of the corner trim system of FIGS. 5 and 8 (without siding or insulation shown).

FIG. 10 is a right end view of the corner trim system of FIGS. 5, 8 and 9 (without siding or insulation shown).

FIG. 11 is a rear view of the corner trim system shown in FIGS. 5, and 8-10.

FIG. 12 is an enlarged detail of the corner shown in FIG. 11.

FIG. 13 is a bottom view of the corner trim system shown in FIGS. 8-12.

FIG. 14 is a cross-sectional perspective view of the general shape/profile of another embodiment of invented trim unit, without an offset, taken about midway between two specialized ends (A-end and/or B-end). This figure also represents an end view of the embodiment prior to cutting/forming its specialized end(s).

FIG. 15 is a cross-sectional perspective view of the general shape/profile of another embodiment of invented trim unit, with an offset and with a “Brick Mold” type front panel, taken about midway between two specialized ends (A-end and/or B-end). This figure also represents an end view of the embodiment prior to cutting/forming its specialized end(s).

### DESCRIPTION OF THE PREFERRED EMBODIMENTS

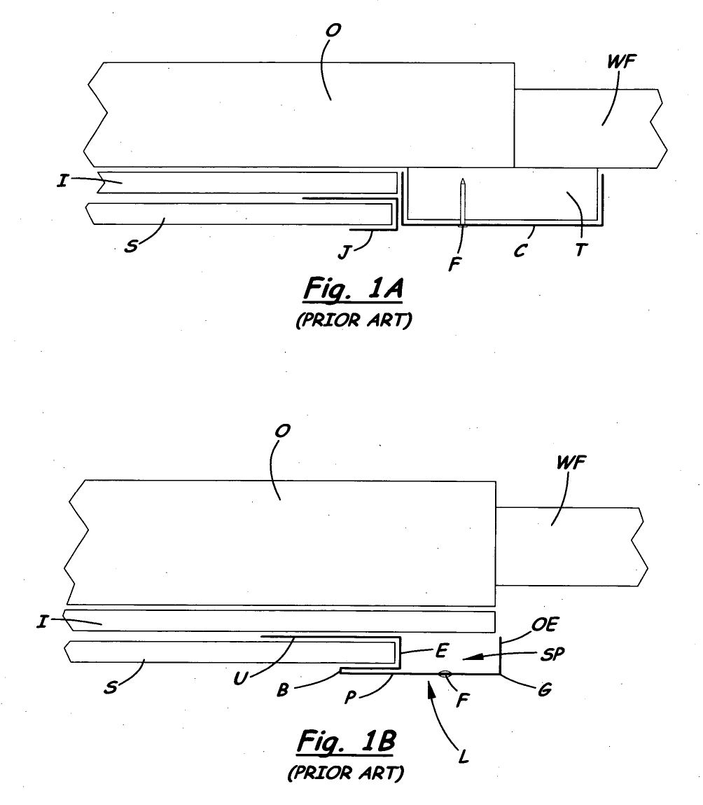

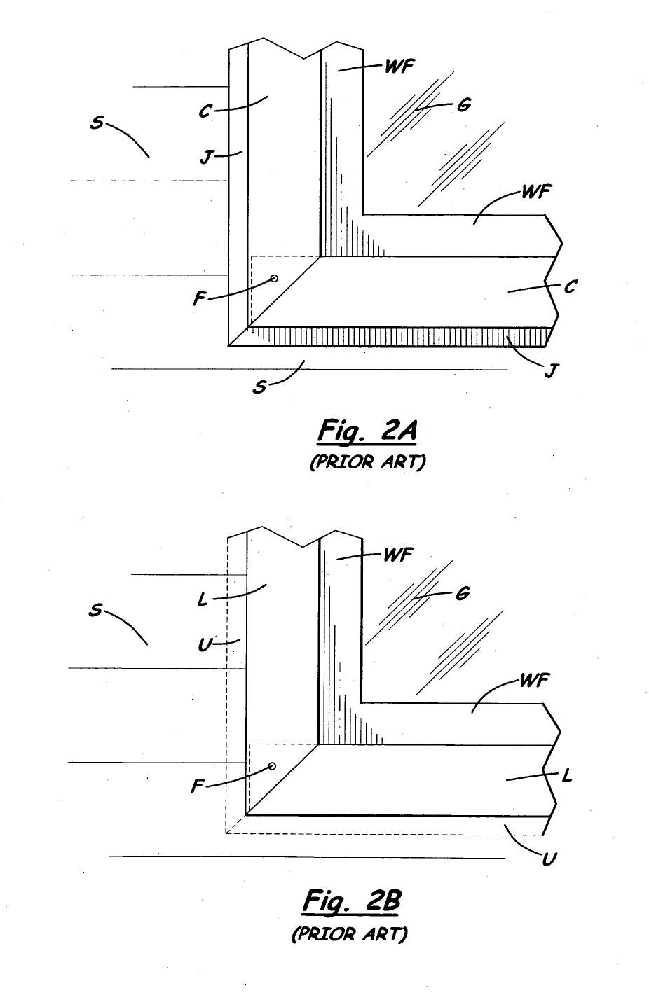

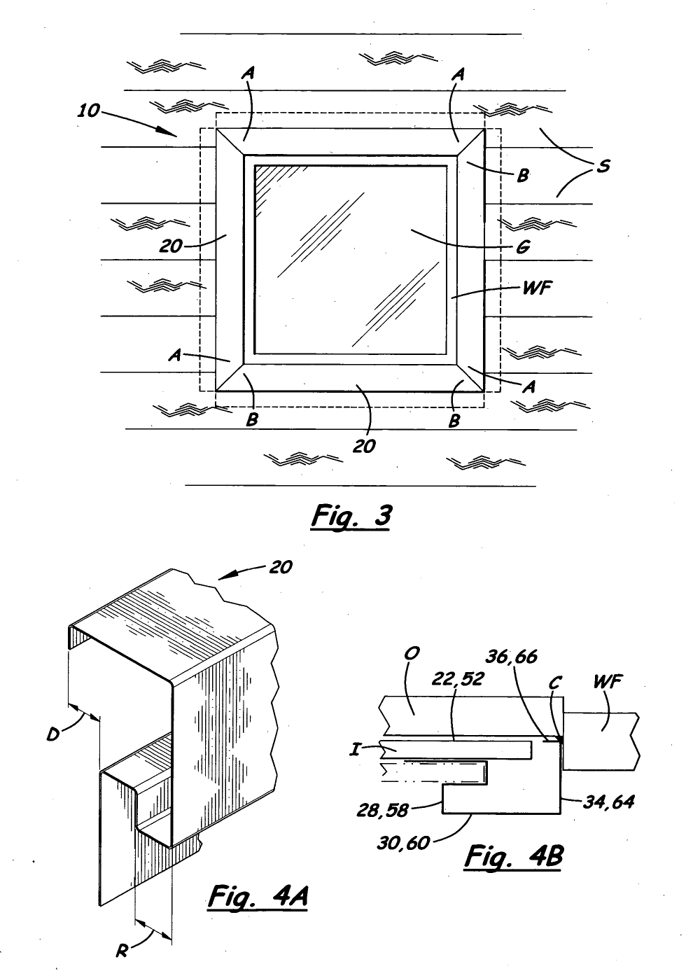

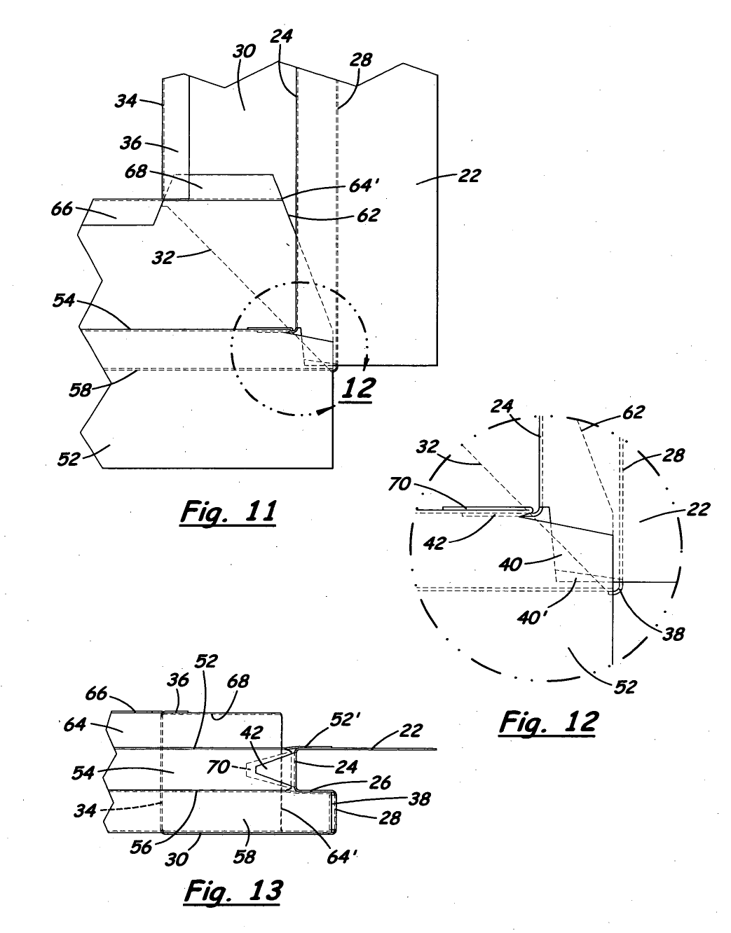

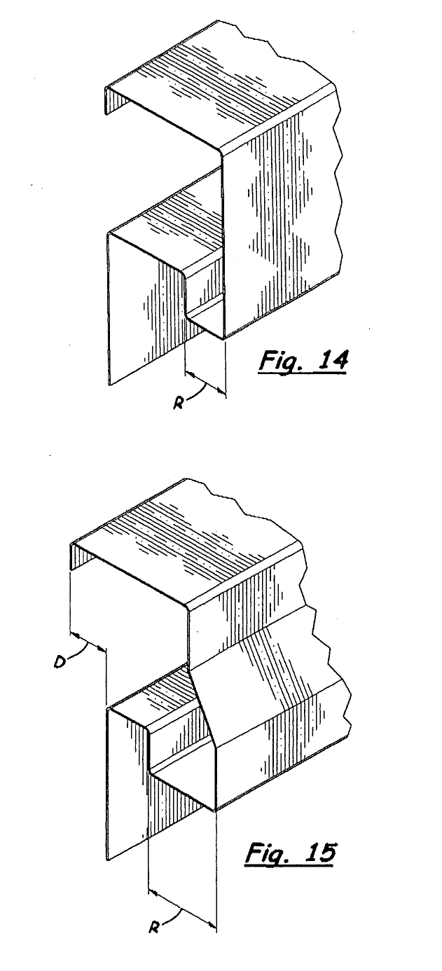

Referring to the Figures, there are shown embodiments of prior art trim systems (FIGS. 1A, B and 2A, B), and one, but not the only, embodiment of the invented trim system (FIGS. 3-13) that may be used for window, door, or other trim, including applications wherein trim units connect with their lengths at an angle to each other, and also wherein the units connect with their lengths parallel and generally colinear with each other. The prior art systems are discussed in the Related Art section, above.

The preferred window trim system 10 comprises a plurality of cooperating trim units 20, which are preferably made of metal, such as steel or aluminum, or other materials that exhibit the desired resilience and resistance to shattering or cracking when flexed and resistance to denting. This resilience and resistance is an important feature of many embodiments of the invention that allows the trim units to be installed in the preferred interlocking fashion without shattering or cracking, as some flexing is needed or desirable during installation.

The window trim units 20 may be manufactured, or cut after manufacture, to comprise either an “A-end” (20A) and an “B-end” (20B) or both B-ends, or both A-ends. As shown in FIG. 3, an A-end cooperates with a B-end. In the preferred installation, the trim system 10 uses a trim unit 20 with two A-ends as the upper horizontal unit, and a trim unit 20 with two B-ends as the lower horizontal unit. In this arrangement, the left vertical trim unit 20 and also the right vertical trim unit 20 each comprise an B-end and an A-end, wherein each B-end cooperates with the A-end of the upper horizontal trim unit 20 and each A-end cooperates with a B-end of the lower horizontal trim unit 20. This arrangement is preferred because the A-ends preferably comprise tabs that bend/overlap across the joint between the trim units. With two A-ends at the top of the window, the tabs of the A-ends will bend across their respective joints and down, tending to urge water to also flow across the joint and down along outer surfaces of the trim units, but not through the joint into the internal spaces and inner surfaces of the trim units and/or to the inner siding surfaces or insulation.

Alternatively, but less preferably (due to the possibility of more moisture finding its way through the joints of the trim), the trim units comprising both A and B ends may be disposed horizontally around the window and the trim units comprising only A ends and only B ends may be disposed vertically around the window. Alternatively, but less preferably (due to the possibility of more moisture finding its way through at least some of joints of the trim), all the trim units may have an A-end and a B-end, with the ends alternating around the perimeter of the trimmed window.

As shown in FIG. 4, the preferred window trim unit 20 comprises an offset D and a relief R. The offset D allows for the trim unit 20 to receive and hide insulation I, so that it is protected from view as well as being protected from exposure to the weather. The relief R provides depth to the window trimming so that it appears more like three-dimensional wood or other material and is more aesthetically-pleasing.

Offset D is particularly beneficial in retrofit siding applications, wherein insulation is typically installed over the original exterior O of the building, and the trim units 20 and cooperating siding are installed over the insulation I. See FIG. 1B, for example. The insulation, therefore, is an additional layer of material on the building that may protrude out farther than the original window frame, which may result in the insulation being exposed to view and/or the elements. Embodiments of the invented trim that include the offset D, therefore, are especially effective in receiving, covering, and/or sealing the insulation away from view and away from the elements.

In new construction applications, the trim units and siding are typically placed over insulation and/or oriented strand board (OSB) that is in a desirable relationship to the window frame, that is, not protruding substantially out from the plane of the window frame. Therefore, after installation of the trim and siding, the insulation is less likely to be visible and exposed to the elements, and embodiments of the invented trim units may not require or substantially benefit from having an offset D.

For ease of description, we will describe the left corner of the window system shown in FIG. 3, with the understanding that other corners comprising an A-end interlocked with a B-end would preferably have the same features but would be oriented according to their position in the window trimming installation. Therefore, orientation terms such as “top,” “bottom,” “left,” “right,” “up,” “down,” are used for convenience in describing the lower, left corner, but do not limit the trim units to a particular orientation.

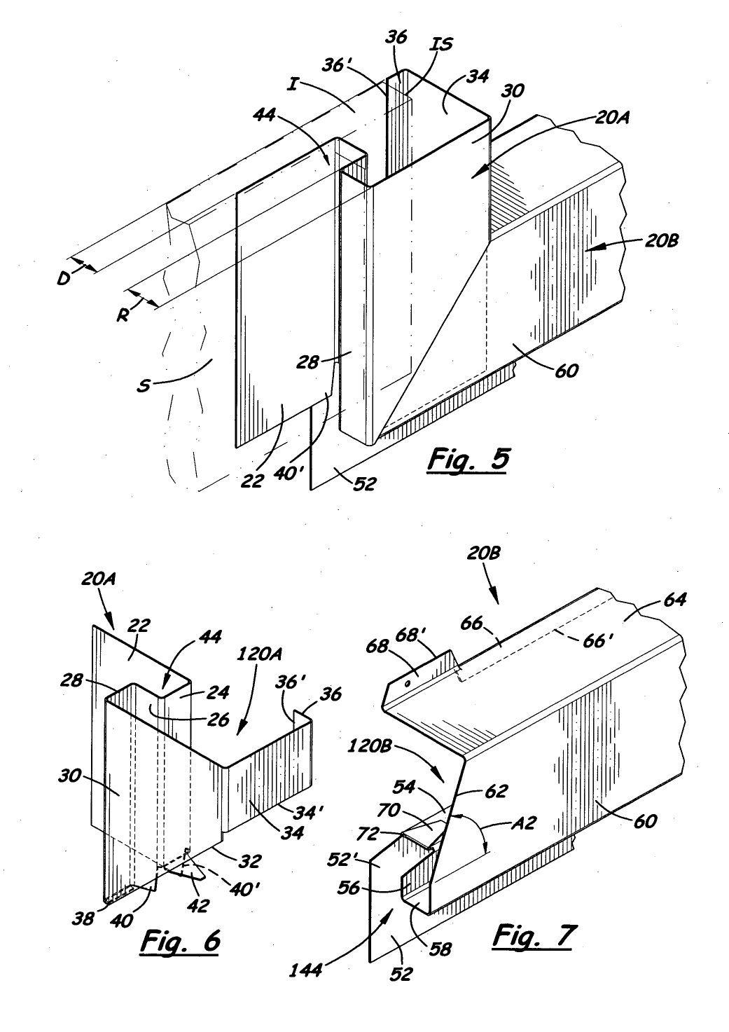

As shown in FIG. 5, the vertical window trim unit 20 having an end 20A cooperates with the horizontal window trim unit 20 having an end 20B, so that the front panels 30, 60 of the vertical window trim and the horizontal window trim each face out from the exterior of the house. Referring to unit 20A, the insulation I is disposed in the offset D between rear flange 36 and behind rear panel 22, so that the insulation I is positioned between the siding S and the original exterior O of the house, and therefore, hidden from view. Referring to unit 20B, insulation is disposed in offset D between flange 66 and rear panel 52. The siding S is received in the channel 44 of the A-end and channel 144 of the B-end. These channels 44, 144 are called-out with separate numbers for convenience in this discussion when describing FIGS. 5-13. It will be understood, however, that the channel of each preferred trim unit extends along its entire length from end to end, and so a single preferred trim unit 20 with both an A-end and a B-end will have a single channel that may be called channel 44 or 144.

As shown in FIG. 6, end 20A of the vertical trim unit 20 comprises a rear panel 22 that is fastened to the house over insulation I, that is, typically with insulation I between rear panel 22 and the outside of the house (O). Front panel 30 extends parallel to the rear panel 22, but is spaced a substantial distance from rear panel 22 by a connection wall system comprising end wall 24, side wall 26, and end wall 28, which, together with rear and front panels 22, 30, form an “S-shaped” cross-sectional profile (see FIG. 6). The front panel 30 is cut or formed with an angled edge 32, which is preferably at 45 degrees to the length of the trim unit. Front panel 30 overlaps the front panel 60 of the cooperating trim unit 20B, and edge 32 simulates the appearance of a 45 degree miter joint. End panel 34 extends preferably perpendicularly from the front panel 30, extending all the way to the plane of rear panel 22. At the distal edge of panel 34 is relatively small flange 36, which is preferably perpendicular to the end panel 34 and extending inward toward the rear panel 22, generally parallel to the rear panel 22 but offset from the plane of rear panel 22 by offset D. As discussed above, however, some embodiments may not include an offset D, and in such cases flange 36 would preferably be coplanar with rear panel 22 (see, for example, FIG. 14).

The offset D is defined by the distance between the flange 36 and the rear panel 22, which is preferably greater than ½ inch, and more preferably, about ⅝-1½ inches to cooperate with commonly-used insulation sheets. A particularly desirable trim unit embodiment is adapted for use with ¾ inch thick insulation and has an offset D of ⅝ inch. Therefore, one may see that the offset D need not be the same as, or greater than, the thickness of the insulation. In fact, an offset D that is slightly smaller than the thickness of the insulation is often desirable, because such an offset allows the trim unit to cover the insulation from view and from the elements, while giving a small amount of leeway in the fit of the trim unit against the insulation (rear panel 22) and against the exterior O (flange 36). See FIG. 4B. This is because there often is a bulge, bump or other incongruity in the exterior O near the window frame, for example, comprising caulking C around the window frame. Such an incongruity typically results in the exterior O bulging outward slightly near the window frame, making the real distance between the surface of exterior O (near the window frame) and the front surface of the insulation (several inches away from the window frame) not equal to, and actually less than, the thickness of the insulation. Hence, making the offset D slightly less than the insulation thickness will allow the flange 36 to lie snugly against the bulging region of the exterior O, while also allowing the rear panel 22 to lie snugly against the front surface of the insulation, without the bulging area pushing the flange 36 outward and causing warping or tilting of the trim unit.

Offset D provides space for the trim unit to receive, cover, and preferably conceal insulation I. The insulation I is installed so that its edge nearest the window is near but preferably not overlapping flange 36 (see FIG. 5). Thus, end panel 34 and flange 36 generally extend around the insulation to the rear of the insulation to shield and conceal the insulation, with the flange 36 preferably co-planar with, or slightly behind, the plane of the back surface of the insulation. With a slight gap between the edge surface IS and the inner edge 36′ of the flange 36, the trim unit may still be easily installed, after the insulation is already on the building, without the flange catching on or smashing the insulation end/edge.

The channel 44 for receiving the siding S is defined by the rear panel 22, end wall 24, and side wall 26. The thickness of the channel 44 is generally the width dimension of end wall 24, or the distance between generally parallel side wall 26 and rear panel 22, which is approximately ⅝-¾ inch for house trim.

Side wall 26, end wall 28, and front panel 30 form a thick trim portion protruding over and in front of the siding S. This creates the three-dimensional appearance or relief of the trim, wherein the relief dimension R is defined by the width dimension of end wall 28, which distances side wall 26 from front panel 30. The width dimension of end wall 28, or generally the distance between parallel side wall 26 and front panel 30, is the measure of relief R, and is preferably greater than ½ inch, and more preferably greater than ¾ inches. An embodiment expected to be popular will have relief R equal to ⅞-1 inch for house trim, which will produce an aesthetically-pleasing “wood frame look.” Relief R creates a trim system profile that is three-dimensional, looking much more like three-dimensional lumber in traditional carpentry than the thin, flat, bent metal of conventional lineal trim.

Therefore, one may say that the preferred trim units have a siding-receiving channel and a protruding trim portion that overhangs the siding when it is installed in the channel. In many but not all embodiments, the preferred dimension of relief R and therefore the thickness of the overhanging trim portion is greater than the thickness of the channel or siding-receiving portion. This may certainly vary, for example, depending on the style of siding and the desired aesthetics of the project.

End wall 28 comprises a rectangular tab 38 as its bottom-most extremity, and end wall 24 comprises a generally triangular tab 42 as its bottom-most extremity, both of which bend generally perpendicularly inward (toward cooperating trim unit 20B). Rectangular tab 38 curves around the edge of wall 58 to extend a short length along the bottom surface of wall 58, serving to cover and/or close the gap between end wall 28 and wall 58 and providing, with its straight edge, a neat- and clean-appearing, visible joint between the trim units 20A and B. Triangular tab 42 curves around edge 72 and extends a length along the bottom surface of wall 54, serving to cover and/or close the gap between end wall 24 and wall 54. Tab 42 and its “joint” with wall 54 is typically not visible, because siding is installed in both channels 44 and 144. However, both tab 38 and 42 help to keep water from running through the respective gaps between trim units 20A and 20B, and, hence, help to keep water from entering the interior of the trim units, called-out as 120A, 120B. It should be noted that tab 42 need not necessarily be triangular in most embodiments, but that the generally triangular shape is a convenient shape to make, as discussed later in the Description.

When the trim units 20 and 20B are joined, side wall corner 40, and rear panel corner 40′, which extend from side wall 26 and rear panel 22, respectively, contact and lie generally parallel to side wall 56 and edge portion 52′ of rear panel 52 (preferably inside channel 144). This overlapping serves as part of the mating/interlocking of the trim units, which helps to stabilize the trim system, shed water, and prevent unsightly gaps between the trim units.

As shown in FIG. 7, the end 20B of the horizontal trim unit 20 comprises a rear panel 52 that is fastened to the house over insulation I, that is, typically with insulation I between rear panel 22 and the house exterior (insulation extending into the offset of trim unit 20B is not shown in the figures, but is understood). Front panel 60 extends parallel to the rear panel 52 but is spaced a substantial distance from rear panel 52 by end wall 54, side wall 56, and end wall 58, which, together with rear and front panels 52, 60, form an “S-shaped” cross-sectional profile (see FIG. 7). The front panel 60 is cut or formed with an angled edge 62, which is preferably at about 60-70 degrees (A2) to the length of the trim unit, but may be other angles and even angles very close to 90 degrees (such as 70-88 degrees, for example), as needed to keep edge 62 out of the way of the cooperating trim unit 20A when the two units are joined. When trim units 20A and B are joined, front panel 30 of trim unit 20A overlaps the front panel 60, hiding edge 62 from view.

End panel 64 extends generally perpendicularly from the front panel 60, extending all the way to the plane of rear panel 52. Panel 64 features relatively small flange 66 that is preferably perpendicular to the end panel 64 and extends inward toward the rear panel 52 on the plane of the rear panel 52. Offset D of trim unit 20B is defined by the distance between the flange 66 and the rear panel 52. As described above in relation to trim unit 20A, offset D provides space for the trim unit to receive, cover, and preferably conceal insulation I, which is not shown in FIG. 7 but is understood to extend along and below trim unit 20B. As discussed above in relation to trim unit 20A, the insulation I is installed so that its edge nearest the window is near but preferably not overlapping with flange 66. See FIG. 4B. Thus, end panel 64 and flange 66 extend generally around the insulation to the rear of the insulation to shield and conceal the insulation, with the flange 66 preferably co-planar with, or slightly in front of (for example, 1/16-¼ inch), the plane of the back surface of the insulation. See above discussion relating to the possible bulging of exterior O in the vicinity of the window frame. With a slight gap between the edge surface IS and the inner edge 66′ of the flange 66, the trim unit may still be installed, after the insulation is already on the building, without the flange catching on or smashing the insulation end/edge.

The channel 144 of trim unit 20B for receiving the siding S is defined by the rear panel 52, end wall 54, and side wall 56. The thickness of the channel 144 is generally the width dimension of end wall 54, or the distance between generally parallel side wall 56 and rear panel 52, which is approximately ⅝-1 inch for house trim.

Panel 64 further comprises an fastener flange 68, which extends 180 degrees relative to flange 66, that is, upwards in FIG. 7. The fastener flange 68 comprises an end 68′ around which trim unit 20A flange 36 “hooks”.

Referring to trim unit 20B, side wall 56, end wall 58, and front 60 form a thick trim portion protruding over and in front of the siding. Relief R is defined by the width dimension of end wall 58, which distances side wall 56 from front panel 60. The width dimension of end wall 58, or generally the distance between parallel side wall 56 and front panel 60, is preferably greater than ½ inch, and more preferably approximately ⅞-1 inch for house trim. As discussed above, relief R creates a trim system profile that is three-dimensional, looking much more like three-dimensional lumber in traditional carpentry than the thin, flat, bent metal of conventional lineal trim.

As discussed above, triangular tab 42 of trim unit 20A curves around edge 72, which is preferably but not necessarily, formed by tab 70 bending 180 degrees over the inner surface of wall 54. Tab 70 typically serves its purpose during the preferred hand-cutting of the ends of the trim units, wherein forming tab 70 may be done by cutting the trim unit material on both sides of tab 70 of the trim unit and then bending tab 70 over to form edge 72. This technique is a much easier way to create edge 72 that trying to cut the trim unit material of wall 54 with “tin snips” in a direction transverse to the length of the trim unit. It would be difficult to maneuver the tin snips for such a transverse cut without warping or otherwise harming the shape of the trim unit; it is easier to fold tab 72 that to cut it away. Alternatively, edge 72 may simply be the cut/formed edge of wall 54, or an edge created by other structure.

From the above description and drawings, it will be understood that the panels, walls, and channels discussed above, extend preferably continuously all the way along the lengths of the trim units. Thus, while called-out with different numbers for A-ends and B-ends for convenience, the separately-called-out panels, walls, and channels are actually the same structure at opposite ends of trim units and part of said continuously-extending structure. For example, if the vertical trim unit shown in FIGS. 3, 5 and 6 has a B-end as its upper end, rear panel 22 extends all the way up to the B-end, where it has edges formed like rear panel 52 but is really the same continuous panel with differently-shaped end edges. Likewise, as discussed above, channel 44 and 144 are really the same, continuously-extending channel formed by walls/panels with differently-shaped end edges. This may be further understood by remembering that all the preferred trim units preferably have identical cross-sectional profiles when cut at any place along their lengths (except within a few inches of the ends), represented by the profile in FIG. 4A.

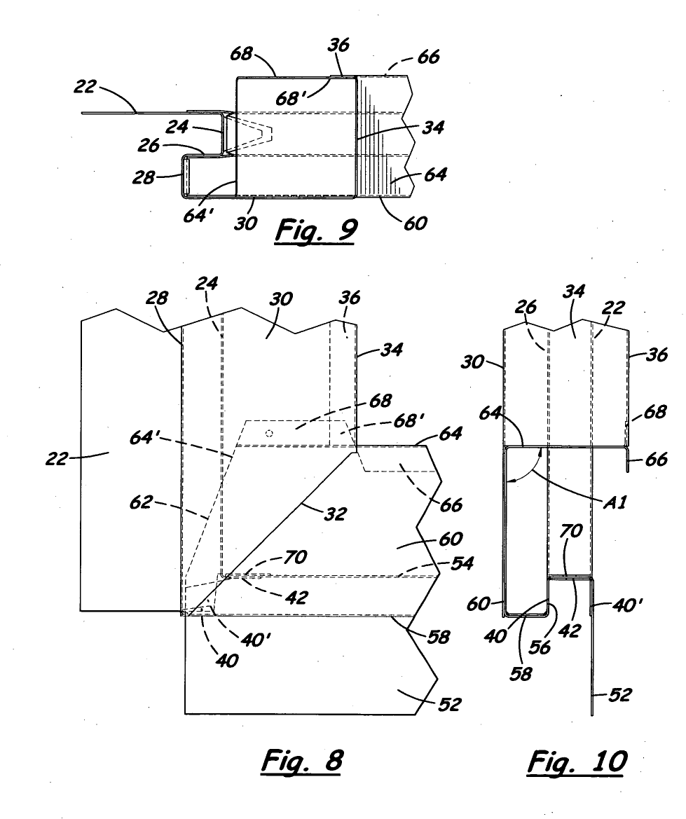

As shown to best advantage in FIGS. 8-13, when the end 20A of vertical trim unit 20 interlocks with the end 20B of horizontal trim unit 20, tab 42 goes under wall 54 so that side wall corner 40 abuts against side wall 56, the rear panel corner 40′ overlaps the end portion 52′ of rear panel 52, and flange 36 “hooks” around the end 68′ of fastener flange 68. The overlap of tab 42 around edge 72 helps prevent rain from getting into the space inside the trim units and causing moisture to reach the insulation I and other interior material. Thus, at several locations in the joint between the two trim unit ends, there is preferably interlocking, frictional engagement or contact, including preferably, from the rear to the front:
a. corner 40′ against portion 52′
b. tab 42 against the outer/bottom surface of panel 54;
c. corner 40 against wall 56;
d. tab 38 against the outer/bottom surface of wall 58;
e. front panel 30 in front of front panel 60, with the rear surface of panel 30 against the front surface of panel 60;
f. edge 34′ against panel 64; and
g. flange 36 against the rear surface of flange 68.

In use, the insulation I is typically installed first, over the original or newly-constructed exterior O. The trim units 20 are installed around the window, door, or other item to be trimmed, by the following preferred steps described below:

1. Position a double-B-end trim unit horizontally underneath the window frame or other item being trimmed, making this the “lower trim unit.”

2. Nail, screw, or otherwise fasten the B-ends of the lower trim unit to the building, by means of one or more nails/screws through the rear panels (52) near the ends of the trim unit, through the insulation I, and into the exterior O. As discussed above, the trim unit preferably installs over the insulation (straight into the paper in FIG. 3) with the flanges 66 clearing the edge surface IS of the insulation to place the flange 66 preferably co-planar or behind the rear surface of the insulation and hiding the edge surface IS. Preferably nails/screws/fasteners are installed through the rear panel at intervals all along the horizontal unit.

3. Nail, screw, or otherwise fasten flanges 68 of the lower unit to the exterior O, while pulling the flange slightly away from the rear panel (upwards in FIGS. 5 and 7), if necessary, so that the rear of panel 64 (near flanges 68 and 66) is higher than the front of the panel 64, that is, panel 64 becomes slightly slanted downward from rear to front. Typically, this means that angle A1 will be greater than 90 degrees, and preferably 95-110 degrees. This way, water hitting panel 64 will tend to run off panel 64 towards at front edge, hence, minimizing the tendency of the water to enter the joints between the trim unit and contact insulation or other inner building materials. Further, water reaching panel 64 inside the trim (near edge 64′, for example, by somehow entering the inside of the vertical trim unit and running down an interior wall of the vertical trim unit), will tend to run forward off of the panel 64 and down to escape the joint at edge 32 or will tend to run under edge 34′ of panel 34 and then run forward off a more central portion of slanted panel 54. This slanting of panel 64 may not be necessary at B-ends that are not on the lower horizontal trim unit, that is, one would tend not to perform this slanting step at the top, B-ends of the vertical trim units.

If the trim units are manufactured so that the panel 64 is slanted (A1 greater than 90 degrees), the installer need not pull the flange 68 away from the rear panel, but, rather, the flange 68 and panel 64 will naturally be in the desired position relative to the front panel 60. This original manufacture (OEM) slant feature is particularly useful for the lower trim unit for run-off of water, as discussed above. This OEM slant feature may also be useful for the side and top trim units (and, hence, present in both panel 64 and panel 34), as this feature may be used to “spring load” the trim unit against the window frame. The installer pushes the side and top trim units against the window frame to an extent that forces panel 34, 64 inward (bringing A1 closer to 90 degrees) and secures the trim units in that position with fasteners through rear panels 22, 52. By means of the preferred natural resilience of the trim unit, this tends to keep a tight seal between the trim unit panels 34, 64 and the window frame.

4. Slide the A-end of each vertical trim unit into and around its respective horizontal unit B-end, so that the tab 42 slides underneath wall 54 and the flange 36 hooks/snaps around the end 68′ of flange 68.

5. Nail or screw the A-ends of the vertical units to the building, by means of one or more nails/screws through the rear panels (22) near the end of the trim unit, through the insulation I, and into the exterior O. Again, the trim unit preferably installs over the insulation (straight into the paper in FIG. 3) with the flange 36 clearing the edge surface IS of the insulation to place the flange 36 preferably co-planar or behind the rear surface of the insulation and hiding the edge surface IS. Because the inner portion of trim unit 20A (panel 34, flange 36) is interlocked with the flange 68 of trim unit 20B, there is typically no need to nail/screw the inner portion (panel 34, flange 36) to the window frame, the exterior O, or to the cooperating unit 20B. Also, the interlocking effect of tab 42 with wall 54, and corners 40, 40′ with 56 and 52′, helps stabilized and secure the connection between unit 20-A and 20-B, and helps eliminate the need for extra nails, screws, and fasteners, and especially visible nails, screws, or other fasteners. Therefore, nails/screws/fasteners need be installed into only the rear panel 22 of the A-ends.

6. At this point, the lower horizontal unit is in place and secured to the exterior O by fasteners through flange 68 and panel 52, and the A-ends of the vertical units are held in place by preferably one fastener through panel 22 (near the lower ends of the vertical units) and by the hooking of flange 36 around flange 68. Thus held, the vertical units may still pivot slightly on the one fastener through panel 22 (with the flange 36 sliding relative to flange 68).

7. The preferred method of installation then includes fastening the top, B-end of one of the vertical units, for example, the left vertical trim unit in FIG. 3, to the exterior O by a fastener through flange 68 and fastening the left vertical unit panel 22 all along its length with multiple fasteners through the insulation I and into the exterior O. Thus, the lower unit and one vertical unit are secured, while the other vertical unit, being held on the lower unit by hooking around flange 68 and by one fastener, may still pivot slightly on that one fastener and by virtue of flange 36 sliding relative to flange 68 during that slight pivot.

8. The top, horizontal, double-A-ended unit (“top unit”) then may be installed onto the vertical units, by first “snapping” the left A-end of the top unit onto the B-end of the left vertical unit (which is secured and does not pivot), while pivoting the top unit slightly upward at its opposite end (right end in this example) and pivoting the right vertical unit slightly out. This way, while the installer is snapping the left end of the top unit, the right end of the top unit and the top end (B-end) of the right vertical unit do not interfere with each other.

9. In this example, the right end of the top unit and the top end of the right vertical unit then may be swung toward each other and slid together, thus forming the last of the four joints between ends of the trim units. Due to the preferred configuration of the A-ends and B-ends, they mate together conveniently (and without bending or damaging the units) when they are brought together at slightly other than 90 degrees and then swung or otherwise pivoted into a 90 degree relationship. After this fourth joint is joined, the rear panels of top and right trim units (22, 52) are secured to the exterior O through the insulation and/through any other underlying materials.

10. Preferably, prior to joining the four joints, the tabs 38 and 42 (of each of the trim units that have them) are not bent, but are parallel and co-planar to the walls from which they extend. Preferably after the four joints have been joined/formed, tabs 38 and 42 are bent to cross over and cover their respective regions of the joint. The tabs at the bottom corners may be said to extend down and inward, and the tabs at the top corners may be said to extend outward and down at the top corners. The tabs may be said to extend from end perimeter edges of the trim units or from portions of the trim units. Note that, in this example, A-ends at the bottom of the two vertical trim units, and two A-ends of the horizontal top unit have tabs 38 and 42, but other arrangement may be used, and alternatively, even tabs extending from B-ends may be used.

11. Siding is then installed into the channels 44, 144 in a conventional manner.

One will note from the above discussion, that no fasteners are visible after the trim is installed and the siding is in place. Specifically, nails, screws, or fasteners are in the rear panels, covered by the siding, and nails, screws, or fasteners are in the flanges 68, hidden by the front panel of the cooperating trim unit. There are preferably no nails/screws/fasteners extending through the front panels 30, 60 or in any other visible place. While screws are preferred, other fasteners may be used, typically but not necessarily with them being threaded; any fastener that attaches the rear panels and flanges 68 to the material behind them may be useful. Having all fasteners being hidden makes the window trim system 10 more aesthetically pleasing, and, again, closer in appearance to quality carpentry wherein nails or screws would be countersunk and covered or not visible at all.

The components of the trim system may be pre-manufactured to have the desired profile, for example, by a roll former or other conventional trim manufacturing or metal bending machine. The A-ends and B-ends may also be pre-manufactured, but it is more desirable to cut/bend these at the job site, in order to have an excellent fit for each window, door, or other application. The installer may take the desired number of trim units (typically four) that preferably look like the trim unit in FIGS. 4, 14, or 15, and then hand-cut each end. The length of the trim unit is determined by measuring the window frame or other structure around which the trim system is to be installed. In the case of a window frame, the installer may measure the horizontal distance between the outer edges of the window frame, and this will generally correspond to the distance between the inner edges of the two flanges 68 (the edges near 68′, for a lower unit with two B-ends, for example). After marking this distance on a piece of trim unit, the two ends may be cut relative to those markings. Then, the installer proceeds as follows:

A. Cut an A-end by cutting away material to leave edge 32 at the desired angle and cutting across panel 34 to form edge 34′. Proceed by snipping and cutting away material from the ends of walls 24, 26, and 28 to form tabs 38 and 42, and corners 40, 40′.

B. Cut a B-end by cutting away material to leave edge 62 at the desired angle and cutting across panel 64 to form the end edge of panel 64. Flange 66 is cut about 2-3 inches from its end, resulting in a flange portion that may be bent 180 from the rest of flange 66 to form flange 68. The ends of walls/panels 52, 54, 56, and 58 are snipped to form the desired edges and tab 70, which may then be bent, as discussed above, to form transverse edge 72.

Other methods of forming the A-ends and B-ends may be used, but these techniques are ones than may be done on the job site with a conventional snipping tool.

By following the above, or similar, installation steps with embodiments of the invention, the inventor has found that installing trim around a window or other region of a building exterior can be done much more efficiently than with prior art trim systems such as shown in FIG. 1A. For example, the inventor has found that a given window can be trimmed with embodiments of the invented system, and embodiments of the invented method, in about ⅓ the time compared to the same window being trimmed with the system in FIG. 1A (20-30 minutes vs. about 90 minutes). Also, the inventor has found that embodiments of the invented trim system and embodiments of the invented method allow training of a new trim installer in a much shorter time that with the prior art systems of FIG. 1A. For example, a new trim installer typically can be trained in 2-3 weeks to properly install trim units according to the invention, while training a new trim installer to install systems such as that shown in FIG. 1A takes months, even as much as 9-12 months.

FIGS. 14 and 15 illustrate two of the many alternative profiles and styles of the invented trim units. The trim unit in FIG. 14 has no offset, but does have a relief. As discussed above, such an embodiment without offset may be effective for new construction wherein both the rear panel and the rear flange (which are preferably generally co-planar) will be placed on a single surface of a single material, for example, on the outer surface of OSB or the outer surface of pre-installed insulation. FIG. 15 illustrates a “brick mold” style trim unit with a front panel bent along two longitudinal lines for a particular desired appearance.

Although this invention has been described above with reference to particular means, materials and embodiments, it is to be understood that the invention is not limited to these disclosed particulars, but extends instead to all equivalents within the scope of the following claims.

I claim:

1. A trim system for exterior siding, the trim system comprising:
first and second trim units joining at an angle to form a trim corner;
wherein each of said first and second units comprises a visible front panel, a rear panel and a rear flange, a connection wall system connecting the rear panel to one edge of the front panel and an end panel connecting the rear flange to an opposing edge of the front panel, the rear panel and rear flange being generally parallel to the front panel;
wherein the connection wall system of each of said first and second unit has a siding-receiving channel and a protruding trim portion, said channel being configured to receive an end or edge of siding, and said trim portion being configured to extend over the end or edge of the siding received in said channel, so that the end or edge of the siding is not visible; and
wherein said second unit further comprises a fastener flange extending from the second unit end panel generally 180 degrees from the rear flange of the second unit, and wherein the first unit connects to the second unit by said rear flange of the first unit hooking around said fastener flange of the second unit.

2. A trim system as in claim 1, wherein said rear panel and said rear flange are on planes that are spaced from the front panel different amounts, so that there is an offset for receiving insulation between the plane of the rear panel and the plane of the rear flange.

3. A trim system as in claim 1, wherein said rear panel and said rear flange are generally co-planar.

4. A trim system as in claim 1, wherein no threaded fasteners extend through said front panels of the first unit and second unit.

5. A trim system as in claim 1, wherein threaded fasteners extend through the rear panels of each of said first and second units for extending into a building exterior, and wherein threaded fasteners extend through said fastener flange for connection to the building exterior, but no threaded fasteners extend through said front panels of the first and second units.

6. A trim system as in claim 5, wherein the trim system comprises no threaded fasteners extending through the first and second units that are visible after siding in installed in the siding-receiving channels.

7. A trim system as in claim 1, wherein said connection wall system of the first trim unit comprises at least one tab that bends across a joint between the between the first and second unit to help prevent water from entering between the first and second units.

8. A trim system as in claim 1, wherein said first unit is vertical and the second unit is horizontal and the end panel of the second unit extends from the second unit front panel at an angle that is greater than 90 degrees so that water runs forward off said end panel.

9. A trim system as in claim 8, wherein the end panel of the second unit is in the range of 95-110 degrees to the front panel of the second unit.

10. A trim system as in claim 1, wherein the front panel of each of said first and second units is distanced from the siding-receiving channel a distance greater than or equal to ¾ inches.

11. A trim system comprising interlocking trim units, each of said trim units forming a siding-receiving channel configured to receive an end or edge of installed siding, and a trim portion overlapping the outer surface of the installed siding, wherein the trim portion has a front panel visible in front of the installed siding and the trim portion has a thickness between the front panel and the front-most wall of the siding-receiving channel of greater than ¾ inches, so that the trim portion protrudes forward greater than ¾ inches relative to the outer surface of the installed siding to give the trim units a three-dimensional appearance.

12. A trim system as in claim 11, wherein two of said interlocking trim units connect to form a trim system corner, wherein a first of said two interlocking units comprises a rear flange and the second of said two interlocking units comprises a fastener flange, wherein said rear flange hooks around said fastener flange to connect the two trim units together, and the rear flange has a length perpendicular to the length of the fastener flange.

13. A trim system as in claim 12, wherein said first of said trim units further has a rear panel, wherein the rear panel and rear flange of said first of said trim units are generally parallel to the front panel of said first trim unit but are on planes that are spaced from the front panel different amounts, so that there is a first unit offset between the plane of the rear panel and the plane of the rear flange for receiving insulation.

14. A trim system as in claim 13, wherein said second of said trim units further has a rear panel and a rear flange, wherein the rear flange of the second trim unit extends 180 degrees from said fastener flange, and wherein the rear panel and rear flange of said second of said, trim units are generally parallel to the front panel but on planes that are spaced from the front panel different amounts, so that there is a second unit offset between the plane of the rear panel and the plane of the rear flange for receiving insulation.

15. A trim system as in claim 13, wherein said first unit offset and said second unit offset are each greater than ½ inches.

16. A trim system as in claim 12, wherein said first and second trim units connect to each other without any threaded fasteners extending through the front panel of the trim units.

17. A trim system as in claim 12, wherein said first and second trim units connect to each other by fasteners through said rear panel of each of the first and second trim units configured to extend into a building exterior underneath the trim units, said hooking of the rear flange around said fastener flange, and at least one threaded fastener through said fastener flange and adapted to extend into the building exterior.

18. A trim system as in claim 11, wherein at least one of said first trim unit and said second trim unit has at least one tab extending from an end perimeter edge of said at least one first or second trim unit and bending across a connection joint between said first and second trim units to block at least some water from entering interior spaced of the trim units.

19. A trim system as in claim 11, wherein said second of said trim units comprises a end panel connecting said fastener flange and said rear flange of the second trim unit to the front panel of the second trim unit, and said end panel is at a slanted position at greater than 90 degrees to the front panel, so that the end panel is adapted to allow water to run off of it toward the front panel.

20. A trim system as in claim 19, wherein the threaded fastener through said fastener flange is configured to attach the fastener flange to the building exterior in a position so that the end panel is pulled upwards to said slanted position and fastened to the building exterior.
